(19) United States
(12) Patent Application Publication
(10) Pub. No.: US 2006/0223945 A1
(43) Pub. Date: Oct. 5, 2006

(54) Low color polyisobutylene succinic anhydride-derived emulsifiers

(76) Inventors: Claire L. Hollingshurst, Derby (GB); David Price, Derby (GB); Thomas F. Steckel, Wickliffe, OH (US); Brian B. Filippini, Wickliffe, OH (US); Nai Z. Huang, Highland Heights, OH (US)

Correspondence Address: The Lubrizol Corporation;Patent Administrator, Mail Drop 022B, 29400 Lakeland Boulevard, Wickliffe, OH, 44092-2298, US

(21) Appl. No.: 10/543,860

(22) PCT Filed: Jan. 20, 2004
(86) PCT No.: PCT/US04/01387

§ 371 Date: Mar. 17, 2006

(30) Foreign Application Priority Data
Jan. 21, 2003 (US) 60441515

(51) Int. Cl. C08F 255/10; C08F 8/32

(52) U.S. Cl. 525/285; 525/301; 525/375; 525/379

(57) ABSTRACT

The invention relates to new synthesis techniques to form emulsifiers of low color from maleic anhydride and polymers of isobutylene. These emulsifiers satisfy a need for a low color component with a long oil compatible hydrophobic tail and a short hydrophilic moiety.

### FIELD OF INVENTION

The invention relates to reaction conditions for the reaction of maleic anhydride with a polyisobutylene having a high percentage of vinylidene terminal units. This reaction yields a polyisobutylene succinic anhydride that can then be formed into various low color surface active agents such as emulsifiers and dispersants. The reactions conditions taught result in unusually low color for this particular compound.

### BACKGROUND OF THE INVENTION

It is well known that maleic anhydride reacts with polyisobutylene containing polymers under a variety of reaction conditions. The reaction products are generally viscous brown fluids. A thermal process uses just heat and the two reactants. A second process using chlorine to react with the polyisobutylene is also used. While the chlorine process facilitates the coupling of the maleic anhydride to the polyisobutylene, there are handling concerns and concerns about residual chlorine/chloride in the reaction product.

U.S. Pat. No. 4,234,435 describes carboxylic acid acylating agents derived from polyalkenes such as polybutenes and dibasic carboxylic reactants such as maleic or fumaric acid. These acylating agents are reacted with other compounds such as polyamines and polyols to produce derivates useful per se as lubricant additives. U.S. Pat. No. 4,708,753 teaches water-in-oil emulsions using a continuous oil phase, a discontinuous aqueous phase, a minor emulsifying amount of at least one salt derived from a hydrocarbyl-substituted carboxylic acid or anhydride or ester or amide derivative of said acid or anhydride, and a functional amount of at least one water-soluble, oil-insoluble functional additive dissolved in said aqueous phase.

U.S. Pat. No. 4,958,034 describes alkenyl succinic anhydrides having a decreased amount of tar and color bodies made by the reaction of an olefin with maleic anhydride in the presence of a specific phosphite and optionally a hindered phenolic antioxidant. U.S. Pat. No. 5,021,169 describes alkenyl succinic anhydrides having a decreased amount of tar and color bodies. It is made by the reaction of an olefin with maleic anhydride in the presence of a specific phosphite and optionally a hindered phenolic antioxidant. U.S. Pat. No. 5,241,003 describes succinimides, succinic esters and succinic ester-amides formed from aliphatic polymers of lower olefins and acidic reactants such as maleic anhydride. The mole ratios of acidic reactants to polymer is desirably at least 1:1, the reaction mixture is maintained under superatmospheric pressure during a substantial portion of the reaction period. The acylating agent is characterized by having an average total tar rating at least 25% lower than a control having made from a polyisobutene having up to 10 percent of a specific end group.

### SUMMARY OF THE INVENTION

A polyolefin succinic anhydride reaction product can be made with a Gardner Color (ASTM D1544) reading of equal to or less than 3 using reaction conditions where excess maleic anhydride relative to the polyolefin is minimized or not present, the surrounding gases and dissolved gases contain minimal oxygen, and the amount of exposure of the reactants to temperatures above 200° C. is minimized. These three reaction parameters, i.e. excess maleic anhydride, dissolved or surrounding oxygen, and elevated temperatures for long times, have been found in combination to contribute significantly to high Gardner Color readings.

The polyolefin preferably has a large percentage of repeating units derived from polymerizing isobutylene, has a number average molecular weight from about 300 to about 10,000, and desirably at least 45% of the polymer chains have terminal vinylidene units. These terminal vinylidene units more readily react with the maleic anhydride. The polyolefin succinic anhydride can be reacted with a polar compound to form a surface active compound. The surface active compounds can function as surfactants, emulsifiers, or dispersants.

The surface active compound, because of its low color on the Gardner Color scale is a desirable surface active compound for use in personal care products, coatings, adhesives, light colored lubricants, metal working fluids and light colored fuels.

### DETAILED DESCRIPTION OF THE INVENTION

The polyolefin reactant used to form the products can generally be any polyolefin polymer but preferably is a polyolefin rich in repeating units derived from isobutylene. Desirably at least 75 and more desirably at least 90 mole percent of the repeating units of the polyolefin are derived from polymerizing isobutylene. These polymers with high amounts of repeating units from isobutylene will be called polyisobutylene polymers for the purposes of this application. Desirably at least 45 and more desirably at least 70 mole percent of the polyolefin will have a vinylidene terminal unit. Examples of these types of polyolefin include Glissopa™ 1000 available from BASF and TPC 595 available from Texas Petroleum Company. Examples of these types of polyisobutylenes are given in U.S. Pat. No. 5,241,003, column 2, in U.S. Pat. No. 4,152,499 and in German Offenlegungsschrift 29 04 314. Other olefin monomers include the various mono and di unsaturated olefins of 2 to about 20 carbon atoms. Generally, the polyolefin has a number average molecular weight of at least 300 to 5000 and more desirably from 300 or 800 to 3000. Generally the polyolefin has from about 20 carbon atoms to about 250 carbon atoms. The polyolefin polymer may be a polyisobutene, polypropylene, polyethylene, a copolymer derived from isobutene and butadiene, or a copolymer derived from isobutene and isoprene.

The second reactant is maleic anhydride or similar compounds such as maleic acid and its esterification products with C1-C8 or C10 alcohols or fumaric acid and/or its esterification products with C-C8 or C10 alcohols. The maleic anhydride may contain small portions of impurities and the diacid (fumaric or maleic or esters thereof, but is desirably fairly pure to avoid adding color bodies to the reaction product. While in the past large excesses of maleic anhydride relative to a 1:1 mole ratio of maleic anhydride:polyolefin have been used to promote functionalization of all or nearly all of the polyolefin with succinic anhydride (note when maleic anhydride loses its carbon-to-carbon double bond in coupling to the polyolefin it becomes succinic anhydride (the saturated derivative of the unsaturated maleic anhydride)). Under some reaction conditions, e.g. with chlorine present, more than one maleic anhydride molecule could be coupled to each polyolefin, e.g. two or more coupled maleic or succinic anhydride groups per polyolefin. After the succinic anhydride is attached to the polyolefin, the anhydride form of succinic acid can covert to the acid form and still remains attached to the polyolefin. Desirably the mole ratio of maleic anhydride and similar compounds, e.g. its acid form or furmaric acid or their esters, to polyolefin present in the reaction mixture is less than 1.3:1. More desirably the mole ratio is less than 1:1 and preferably is it from about 0.6:1 to about 0.9 or 1:1.

The reaction product of a polyolefin with maleic anhydride or similar compounds, e.g. succinic anhydride functionalized polyolefin, has some surface activity as the anhydride, and it can be reacted with a polar compound/molecule to increase its surface activity. The polyolefin portion of the molecule is very oleophilic (hydrophobic) but the anhydride portion is only somewhat hydrophilic as an anhydride. Opening the anhydride by converting it to a succinic acid functionalized polyolefin gives a reaction product with increased surface activity. Converting the acid form to the salt of the acid with a strong base further promotes the surface activity of the molecule. It is desirable when making low color surface active derivatives of succinic anhydride functionalized polyolefins with low color on the Gardner color scale, such as 3 or less or more desirably 2 or less, to start with low color succinic anhydride or succinic acid functionalized polyolefin.

For the purpose of this application a surface active compound will be defined as something that has an affinity and tends to migrate to interfaces between two liquids, a liquid or solid and a gas, or a liquid and a solid. Other names particular to the function of a surface active agent are surfactants, emulsifiers, and dispersants. These compounds migrate to these interfaces because of the attraction of one portion of the surface active molecule for one liquid or solid and a similar attraction of another portion of the surface active molecule for a different liquid or solid. The ability of the surface active compounds to migrate to these interfaces and sometimes to reduce the surface tension of the liquid or solid at the apparent interface helps to create and or stabilize various dispersions of liquids and solids. These dispersions include but are not limited to water in oil emulsions, oil in water emulsions, dispersions of a solid in a liquid, dispersions of a liquid or solid in air, or what is known as multiple phase dispersions where one of the above types of dispersions is dispersed in another medium such as a water in oil in water dispersion.

In one embodiment the surface active compound with low color of the invention is a polyisobutylene succinic anhydride derivative such as a polyisobutylene succinimide or derivatives thereof. Other typical derivatives of polyisobutylene succinic anhydride include hydrolyzed forms, esters therefrom, diacids therefrom, or salts of mono or diacids. A large group of polyisobutylene succinic derivatives are taught in U.S. Pat. No. 4,708,753, herein incorporated by reference. Similar derivatives for use in fuel are taught in U.S. Pat. No. 6,383,237 (hereinafter U.S. Pat. No. '237) In one embodiment, the succinic anhydride or succinic acid substituted polyolefin is a hydrocarbyl-substituted succinic acid or anhydride represented correspondingly by the formulae 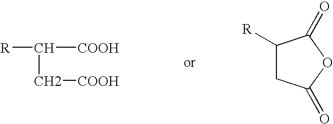
wherein R is hydrocarbyl group of about 20 to about 200 carbon atoms. Hydrocarbyl groups or substituents refers to a group having one or more carbon atoms directly attached to the remainder of the molecule having a hydrocarbon nature or predominantly so and includes 1) pure hydrocarbon groups (e.g. alkyl, alkenyl, alkylene, and cyclic materials), 2) substituted hydrocarbon groups, which are still predominantly hydrocarbon in nature (e.g. halo, hydroxyl, alkoxy, mercapto, alkylmercapto, nitro, nitroso, and sulfoxy), and 3) heterosubstituted hydrocarbon groups such as described in 2) with no more than 1 or 2 halogen, oxygen, sulfur, or nitrogen atoms or combinations per 10 carbon atoms. The conventional production of these polyolefin-substituted succinic acids or anhydrides via alkylation of maleic acid or anhydride or its derivatives with a halohydrocarbon (e.g. chlorine process) or via reaction of maleic acid or anhydride with an olefin polymer having a terminal double bond is well known to those of skill in the art and need not be discussed in detail herein.

The surface active compound may be formed using ammonia and/or an amine as the polar molecule. The amines useful for reacting with the succinic anhydride or succinic acid functionalize polyolefin with a polar molecule to form the product (i) include monoamines, polyamines, and mixtures thereof.

The monoamines have only one amine functionality whereas the polyamines have two or more. The amines may be primary, secondary or tertiary amines. The primary amines are characterized by the presence of at least one —NH₂ group; the secondary by the presence of at least one H—N< group. The tertiary amines are analogous to the primary and secondary amines with the exception that the hydrogen atoms in the —NH₂ or H—N< groups are replaced by hydrocarbyl groups. Examples of primary and secondary monoamines are in U.S. Pat. No. '237 column 16. The amines may be hydroxyamines. The hydroxyamines may be primary, secondary or tertiary amines. Typically, the hydroxamines are primary, secondary or tertiary alkanolamines. The alkanol amines may be represented by the formulae:

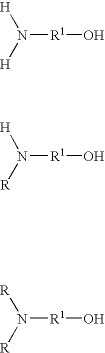

further described in U.S. Pat. No. '237 columns 16 and 17 where R is an alkanol and R¹ is an alkylene. A preferred amine is triethanolamine due to its low contribution to color and low odor.

The amine may be an alkylene polyamine. Especially useful are the linear or branched alkylene polyamines represented by the formula 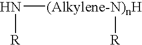
wherein n has an average value between 1 and about 10, and in one embodiment about 2 to about 7, the “Alkylene” group has from 1 to about 10 carbon atoms, and in one embodiment about 2 to about 6 carbon atoms, and each R is independently hydrogen, an aliphatic or hydroxy-substituted aliphatic group of up to about 30 carbon atoms. These alkylene polyamines are described in U.S. Pat. No. '237 column 18. Ethylene polyamines are useful. In one embodiment, the amine is a polyamine bottoms or a heavy polyamine. The term “polyamine bottoms” refers to those polyamines resulting from the stripping of a polyamine mixture to remove lower molecular weight polyamines and volatile components to leave, as residue, the polyamine bottoms. In one embodiment, the polyamine bottoms are characterized as having less than about 2% by weight total diethylene triamine or triethylene tetramine. These are described in U.S. Pat. No. '237 in column 18.

The succinic anhydride substituted polyolefin reacted with a polar group may be a salt, an ester, an amide, an imide, or a combination thereof. The salt may be an internal salt involving the succinic anhydride or succinic acid substituted polyolefin and the ammonia or amine wherein one of the carboxyl groups becomes ionically bound to a nitrogen atom within the same group; or it may be an external salt wherein the ionic salt group is formed with a nitrogen atom that is not part of the same molecule. In one embodiment, the amine is a hydroxyamine, and the resulting oil-soluble product (i) is a half ester and half salt, i.e., an ester/salt. The reactions to form these products are in U.S. Pat. No. '237 in column 17.

The succinic anhydride substituted polyolefin reacted with a polar group may be made by reacting an succinic anhydride substituted polyolefin with at least one ethylene polyamine such as TEPA (tetraethylenepentamine), PEHA (pentaethylenehexaamine), TETA (triethylenetetramine), polyamine bottoms, or at least one heavy polyamine. The ethylene polyamine can be condensed to form a succinimide. The equivalent ratio of the reaction for CO:N is from 1:1.5 to 1:0.5, more preferably from 1:1.3 to 1:0.70, and most preferably from 1:1 to 1:0.70, wherein CO:N is the carbonyl to amine nitrogen ratio.

In one embodiment, the succinic anhydride substituted polyolefin reacted with a polar group may be made from a polyolefin having about 20 to about 50 carbon atoms, and a second polyolefin having about 50 to about 250 carbon atoms. In this embodiment, the polyolefin portion of the products are different in molecular weight and function in the final formulation.

In one embodiment, the succinic anhydride substituted polyolefin reacted with a polar group may comprise two different materials in terms of molecular weights or the polar group and the first and second material may be coupled together by a linking group derived from a compound having two or more primary amino groups, two or more secondary amino groups, at least one primary amino group and at least one secondary amino group, at least two hydroxyl groups, or at least one primary or secondary amino group and at least one hydroxyl group.

The two different succinic anhydride substituted polyolefins may be reacted with the linking compound according to conventional ester and/or amide-forming techniques. This normally involves heating succinic anhydride substituted polyolefin with the linking compound, optionally in the presence of a normally liquid, substantially inert, organic liquid solvent/diluent. The reaction between the linked succinic anhydride or succinic acid substituted polyolefins and the ammonia or amine may be carried out under salt, ester/salt, amide or imide forming conditions using conventional techniques.

In one embodiment the succinic acid or succinic anhydride functionalized polyolefin is reacted with a polyol. The polyol can be a compound represented by the formula
R—(OH)ₘ
wherein in the foregoing formula, R is an organic group having a valency of m, R is joined to the OH groups through carbon-to-oxygen bonds, and m is an integer from 2 to about 10, and in one embodiment 2 to about 6. The polyol may be a glycol, a polyoxyalkylene glycol, a carbohydrate, or a partially esterfied polyhydric alcohol. Examples of the polyols that may be used include ethylene glycol, diethylene glycol, triethylene glycol, tetraethylene glycol, propylene glycol, dipropylene glycol, tripropylene glycol, dibutylene glycol, tributylene glycol, 1,2-butanediol, 2,3-dimethyl-2,3-butanediol, 2,3-hexanediol, 1,2-cyclohexanediol, pentaerythritol, dipentaerythritol, 1,7-heptanediol, 2,4-heptanediol, 1,2,3-hexanetriol, 1,2,4-hexanetriol, 1,2,5-hexanetriol, 2,3,4-hexanetriol, 1,2,3-butanetriol, 1,2,4-butanetriol, 2,2,6,6-tetrakis-(hydroxymethyl) cyclohexanol, 1,10-decanediol, digitalose, 2-hydroxymethyl-2-methyl-1,3-propanediol-(tri-methylolethane), or 2-hydroxymethyl-2-ethyl-1,3-propanediol-(trimethylopropane), and the like. Mixtures of two or more of the foregoing can be used.

In one embodiment, the polyol is a sugar, starch or mixture thereof. Examples of these include erythritol, threitol, adonitol, arabitol, xylitol, sorbitol, mannitol, erythrose, fucose, ribose, xylulose, arabinose, xylose, glycose, fructose, sorbose, mannose, sorbitan, glucosamine, sucrose, rhamnose, glyceraldehyde, galactose, and the like. Mixtures of two or more of the foregoing can be used.

In one embodiment, the polyol is a compound represented by the formula
HO(CH₂CH(OH)CH₂O)ₙH
wherein n is a number in the range of 1 to about 5, and in one embodiment 1 to about 3. Examples include glycerol, diglycerol, triglycerol, and the like. Mixtures as well as isomers of the foregoing may be used.

In one embodiment, the polyol is a polyhydric alcohol having at least three hydroxyl groups, wherein some of the hydroxyl groups are esterfied with an aliphatic monocarboxylic acid of about 8 to about 30 carbon atoms, but at least two of the hydroxyl groups are not esterfied. Examples include monooleate of glycerol, monostearate of glycerol, monooleate of sorbitol, distearate of sorbitol, di-dodecanoate of erythritol, the like. Mixtures of two or more of the foregoing can be used. In a preferred embodiment the polyol is glycerol.

The surface active compound derived from reacting the succinic anhydride substituted polyolefin may be present in the various formulated products of the invention at a concentration of about 0.1 to about 15% by weight, and an one embodiment about 0.1 to about 10% by weight, and in one embodiment about 0.1 to about 5% by weight, and in one embodiment about 0.1 to about 2% by weight.

Other ionic or nonionic surface active compounds may be included in formulated products according to the invention. They may have a hydrophilic lipophilic balance (HLB) in the range of about 1 to about 20 or 30, and in one embodiment about 4 to about 15 or 20. Examples of these compounds are disclosed in McCutcheon's Emulsifiers and Detergents, 1998, North American & International Edition. Pages 1-235 of the North American Edition and pages 1-199 of the International Edition are incorporated herein by reference for their disclosure of such ionic and nonionic compounds having an IEd in the range of about 1 to about 10 or 30. The ionic or nonionic compounds include poly(oxyalkene) compounds. The other ionic or nonionic compound (ii) may be present in the formulations s of the invention at a concentration of about 0.01 to about 30% by weight, and in one embodiment about 0.01 to about 20% by weight, and one embodiment about 0.01 to about 5% by weight, and in one embodiment about 0.01 to about 3% by weight.

The formulated products of the invention include various products where the highly colored surface active compounds of the prior art were not accepted or where the higher content of colored bodies was undesirable. These include coatings, inks, lubricants having low color, adhesives, fuels having low color, and personal care products. The surface active compounds can be used to disperse solids in inks or coating, disperse liquids or gases in liquids in coatings or inks, or change the rheological properties of coatings or inks. These functions of surface active compounds in general in coatings and inks are known. Similar functions including dispersing combustion products or contaminants occur when used in lubricants, fuels, adhesives, and metal working applications. These surface active compounds can perform the same functions in personal care products along with additional functions. For example the surface active compounds of this invention impart a very desirable feel to human skin when applied in appropriate amounts with an oil or water based formulation. Personal care formulations that benefit from the low color surface active compounds of this disclosure include body care products in general like skin and hair products. These products can be further broken down into shampoos, soaps, body wash, emollients, crime rinses, lotions, facial products, cosmetics (make-up), lip stick, lip gloss, lip protectorants from wind and weather, facial cleansers, shave creams, hair removal products, etc.

Due to the wide variety of functions of oils in the formulated products of this disclosure oils will be defined as oleophilic materials (generally opposite of hydrophilic). These include petroleum distillates, silicone oils, esters of various mono, di, and polyacids with various mono, di, and polyhydric alcohols including synthetic esters and the naturally derived glycerol esters common to vegetable and animal oils. Oils will also include the API group I-V oil basestocks which are overlapping with the above description in many aspects.

Oils also include the many products derived from plants and animals that have been used in personal care products that don't fall within the above descriptions of petroleum distillates and ester oils.

Formulated products as defined above can include a variety of other components for a variety of functions. Personal care products often include surface active compounds (in addition to the low color ones derived from succinic anhydride functionalized polyolefin) for cleansing purposes or to promote spreading of the formulation on a surface; scents or aromatic compounds to give a favorable smell to the product; moisturizers and oils to condition the surface to which the product is applied; rheology control agents to give the product an appropriate viscosity; pharmaceutically active compounds to treat damaged surfaces, prevent growth of harmful species on the surface, stimulate blood flow, reduce swelling or inflammation, etc.; and agents to block wind, sun, or air damage to the surface.

The process to make the low color succinic anhydride or succinic acid functionalized polyolefin of this disclosure differs from the prior art in that it neither uses the various phosphite agents thought to minimize the formation of colored species nor does it utilizes any purposefully added antioxidants during the reaction of the maleic anhydride with the polyolefin to form the succinic anhydride or succinic acid funtionalized polyolefin. Rather the process minimizes the amount of maleic anhydride to a molar ratio of less than 1.3 and more desirably less than 1 to the polyolefin. This would not have been attempted in the prior art as the maleic anhydride is the cheaper component and generally the drafters sought to use an excess of the cheaper reactant to force the more complete utilization of the more expensive component. The prior art also taught that by using an excess of the maleic anhydride one could often attach two succinic anhydride groups to a single polyisobutylene and thus somehow get greater effectiveness of the product without using more polyisobutylene. Further, the presence of colored bodies seems to promote the formation of additional colored bodies (side reactions) so the reactors must be kept clean and the reactants heated only for so long as is necessary to get the desired level of coupling of the two reactants. The excess maleic anhydride may be removed by distillation after the reaction. In this particular process the excess polyolefin may be left in for possible desirable effects of non-funtionalized polyolefin. The presence of excess non-functionallized polyolefin was generally avoided in the past. Finally the amount of dissolved oxygen in the reactants and above the reactants in the reaction vessel is desirably minimized to minimize the development of colored bodies. A nitrogen or argon sparge of the reactor contents has proven particularly effective.

The term water-soluble refers to materials that are soluble in water to the extent of at least one gram per 100 milliliters of water at 25° C. Water insoluble refers to materials less soluble in water.

The term oil soluble refers to materials that are soluble in a SAE 30 paraffinic base oil lubricant to the extent of at least one gram per 100 milliliters of lubricant at 25° C. Solubility will be determined visually as lack of a second phase, transparency, and lack of sediment. A material which is less soluble in SAE 30 paraffin oil than 1 g/100 mL of oil at 25° C. will be classified as oil-insoluble.

The low color succinic anhydride functionalized polyolefin and the derivatives therefrom according to the invention will desirably not include in the process of manufacturing the use of effective amounts of phosphite color inhibitors such as disclosed in U.S. Pat. Nos. 4,958,034 or 5,021,169; phosphorus containing sequestrants, hydroxy aromatics to inhibit color formation, amino aromatics to inhibit polymer formations, inorganic halogen compounds such as dry HCl or calcium bromide to prevent tar formation; hindered phenols, phosphite esters, and/or substituted hydroquinones. Further the low color succinic anhydride functionalized polyolefin and the derivatives therefrom desirably does not include in the manufacturing process the use of color removing clay filter media, activated carbon filter media, and other post-reaction steps to sequester or remove colored bodies. The process would desirably include a simple filtration through a mechanical filter media to remove any contaminants such as particulate matter from the finished product.

### EXAMPLES

The following examples illustrate the invention. It should however be noted that these examples are non exhaustive and not intended to limit the scope of the invention.
Chemical Equation:

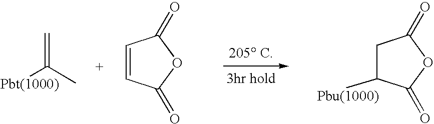

### Example 1

### Procedure for Preparation of Low Color Succinic Anhydride Functionalized Polyisobutylene (PIBSA)

1. Charge the Glissopal™ 1000 (1900.00 g) and maleic anhydride (167.70 g) to a 3 L wide-necked flange flask.

2. The flange flask was closed with a flange lid and clipped. The vessel was equipped with a PTFE stirrer gland, stirrer rod, and overhead mechanical stirrer, nitrogen inlet valve (nitrogen released below the reactant surface gives slightly lower color than released above said surface), thermocouple with eurotherm heating system for 3 L isomantle, and an air condenser capped with a single surface Liebig condenser.

3. The sealed reaction vessel was purged with nitrogen.

4. The reaction mixture was heated, with stirring at 400 rpm, to 210° C. (maleic anhydride may escape as a gas above 180° C.).

5. Once 210° C. was reached, the reaction was held for 3 hours.

6. The temperature was then dropped to 200° C., and the reaction set-up was changed ready for vacuum distillation, i.e. the nitrogen inlet was removed, and the air condenser was removed and replaced with a still-head, air condenser, vacuum receiver adapter, and round-bottomed flask (cooled with dry ice).

7. Full vacuum (−29 inHg=23.4 torr) was applied for a minimum of 1 hour.

8. The product was then cooled to ˜180° C. and filtered through ½″ Fax-5 filter-aid and grade 1 glass sinter funnel, using −29 inHg vacuum, and a heat-lamp. This step aids in removing any fine particles, improves the clarity, and does not appreciably compromise color.

9. The product was a pale yellow colour.

The analysis of this material was as follows:

Total Acid Number: 74-79 mg KOHg⁻¹

Free PIB (polyisobutylene): 32-33%

Kinematic Vis@100: 371-375 cSt

Color (D1500): L1.0

JTU: 3-16, preferably the lower the better though

### Example 2

### Procedure for Preparing a Low Color Succinic Anhydride Functionalized Polyisobutylene (PiBSA) Under Pressure

An alternative procedure for making low color PiBSA's under pressure is described.

1) A Parr reactor is charged with maleic anhydride (35 g) and Glissopal™ 1000 (360 g).

2) The reactor is sealed and connected to the stirrer.

3) A nitrogen line is attached to the sub-surface sparge tube and, after ensuring the outlet valve is open, a steady nitrogen purge is applied for 15 min.

4) After 15 min, the reactor is sealed and pressurized to 15-20 psig.

5) The reactor is heated to 60° C., and the stirrer started.

6) The temperature of the reactor is raised to 205° C.

7) Once at 205° C., the reaction was held at this temperature for 3 hours.

8) After 3 hours, the reactor was cooled to 80° C. The pressure was released and the reactor disassembled.

9) The contents of the reactor were poured into a 500 ml flange flask and the flask equipped for vacuum distillation.

10) The flask was heated to 200° C. whilst maintaining a sub-surface nitrogen purge. Once at 200° C., the sub-surface nitrogen tube was removed and full vacuum applied (28″ Hg) for 2 hours.

11) After 2 hours, the flask contents were cooled to 80° C. and filtered under vacuum through a pad of FAX-5 to yield the product.

The analysis of this material was as follows:

Total Acid Number: 78 mg KOHg⁻¹

Free PIB: 32.66

Kinematic Vis@100: 436 cSt

Color (D1500): L1.0

JTU: 9.7

Conversion of succinic anhydride substituted polyolefin (PIBSA) into emulsifier:

### Example 3

### Making a Surface Active Compound. PIBSA/triethanolamine (TEA)

A 5000-mL flask was charged with 100 g (0.125 equivalents) of PIBSA prepared as in example 1 and 72.9 g oil. The flask was equipped with a stirrer, thermowell, and above-surface N₂ inlet. The system was flushed with N₂ gas at 0.1 scfh, heated to 58° C. and 9.34 g (0.063 moles) triethanolamine was added over 1 minute at 58-62° C. The mixture was heated to 75° C. and held at 75° C. for 2 hours to give a product with analyses of % N=0.51, acid number=21.4, and base number=18.9. The intended product is a PIB succinic ester/salt.

### Example 4

### Making a Surface Active Compound. PIBSA/NaOH

A 500-mL flask was charged with 77.2 g (0.1 equivalents) of PIBSA prepared as in example 1 and 81.2 g oil. The flask was equipped with a stirrer, thermowell, and above-surface N₂ inlet. The system was flushed with N₂ gas at 0.1 scfh and heated to 58° C. The 4 g (0.05 equivalents) of a 50% aqueous NaOH solution was added over 3 minutes at 75-78° C. The mixture was heated to 95° C. and held at 95° C. for 4 hours to give a product with base number=19.3. The intended product is the sodium salt of a PIB succinic acid.

### Example 5

### Making a Surface Active Compound. PIBSA/Glycerol

A 500-mL flask was charged with 136.1 g (0.18 equivalents) of PIBSA prepared as in example 1 and 4.8.1 g oil. The flask was equipped with stirrer, thermowell, and above-surface N₂ inlet. The system was flushed with N₂ gas at 0.1 scfh and heated to 80° C. Then 8.28 g (0.09 moles) of glycerol was added over 3 minutes at 80-78° C. The mixture was heated to 110° C. and held at 110° C. for 6 hours to give a product with acid number=19.3. The intended product is a PIB succinic ester/acid.

The emulsifier prepared from the reaction of PIBSA/TEA (Example 3) was used as “Example 3” in the formulations below.

### Example 6

### “Formula for W/O Barrier Cream”

| Component | % composition |
|---|---|
| Example 3 | 3.0% |
| Sorbitol Sol'n, Aq., 70% | (27% active component) |
| Mineral Oil | 10.0% |
| Beeswax | 1.0% |
| Gulf Wax | 1.0% |
| Zinc Oxide | 20.0% |
| Water | 38.0% |

### Example 7

### “SPF 45 W/O Sun Protection Lotion”

| | |
|---|---|
| Component | % Composition |

Phase A

| | |
|---|---|
| Example 3 | 1.5-3.0% |
| Octyl Stearate | 10.0-11.5% |
| Mineral Oil | 11.00% |
| Hydrogenated Castor Oil | 0.80% |
| Microcrystalline Wax | 1.20% |
| Avobenzone | 2.00% |
| Oxybenzone | 4.00% |
| Homosalate | 15.00% |
| Octisalate | 5.00% |
| Octocrylene | 1.60% |

Phase B

| | |
|---|---|
| D.I. Water | 45.90% |
| Sodium Chloride | 0.50% |
| TOTAL | 100% |

Preparation Instructions:
1. Heat Phases A and B to 70-75° C.
2. Slowly add Phase B to Phase A with good mixing
3. Cool to 30° C.
4. Package

### Example 8

### “High Water Content Water/Oil Skin Cream”

Phase A

| | |
|---|---|
| Example 3 | 1.0% |
| Cyclomethicone | 1.5% |
| Polypropylene glycol -15 stearyl ether | 1.5% |
| Isohexadecane | 6.0% |

Phase B

| | |
|---|---|
| Glycereth-26 | 4.5% |
| Magnesium sulfate | 0.8% |
| Water | 84.5% |
| Preservative | 0.1%. |

Phase C

| | |
|---|---|
| Fragance | 0.1% |

Heat Phases A and B to approximately 80 ° C.
Slowly add Phase B to Phase A while mixing vigoriously.
Homogenize thoroughly for one minute.
Allow to cool to <35° C. Add Phase C with stirring.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

Each of the documents referred to above is incorporated herein by reference. Except in the Examples, or where otherwise explicitly indicated, all numerical quantities in this description specifying amounts of materials, reaction conditions, molecular weights, number of carbon atoms, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

1. A composition comprising;
a) a reaction product from the reaction of a polyolefin polymer having at least 20 carbon atoms with maleic anhydride, maleic acid, fumaric acid, or their esters or combinations thereof having a color on the Gardner Color scale of equal to 2 or less than 3,
b) optionally further reacted with a polyol, alkanolamine, amine, or ammonia or another base, or combinations thereof and optionally, including a diluent oil.

2. The composition of claim 1, wherein said polyolefin polymer comprises at least 80 wt. % repeating units from isobutylene and wherein said polyolefin has a molecular weight from about 300 to about 10,000.

3. A composition according to claim 1 wherein a polyol is reacted with said reaction product and said polyol comprises glycerol, and wherein an alkanol amine is reached with said reaction product and said alkanol amine comprises triethanol amine

4. A composition comprising:
a) a reaction product from the reaction of a polyolefin polymer having at least 20 carbon atoms with maleic anhydride and/or maleic acid forming a succinic anhydride functionalized polyolefin,
b) further reacting said functionalized polyolefin with a polyol, alkanolamine, amine, or ammonia or another base, or combinations thereof, and
c) optionally diluting with a diluent oil,
wherein said reaction product of steps “a” and “b” has a color on the Garner Color scale of equal to or less than 2.

5. A process for making a low color polyisobutylene succinic anhydride or surfactant therefrom from reacting a polyolefin with maleic anhydride, maleic acid, fumaric acid, or their esters comprising:
reacting a polyolefin having at least 20 carbon atoms and at least one carbon-to-carbon double bond with maleic anhydride in its anhydride or acid form or fumaric acid or the esters of maleic or fumaric acid in a molar ratio of total maleic anhydride, maleic acid, fumaric acid and their esters to polyolefin of less than 1.3 to 1; optionally further reacted with a polyol, alkanolamine, amine, or ammonia or another base, or combinations thereof; and
optionally diluted with a diluent oil;
and wherein the color of the resulting reaction product is equal to or less than 2 on the Gardner Color scale.

6. A process according to claim 5, wherein the reaction time, measured as time at which the reactants are together at a temperatures above 195° C., is 12 hours or less and the polyolefin is at least 50 mole percent functionalized with the maleic anhydride in its succinic anhydride or succinic acid form, and wherein the reaction product is formed in a reactor using an inert gas to remove most of the dissolve oxygen and oxygen above the reactants, and wherein the reaction product is filtered.

7. A process according to claim 5, wherein said polyolefin is characterized as having a terminal vinylidene groups on 45 mole % or more of the polyolefin reactant before reaction with the maleic anhydride in its anhydride or acid form.

8. A process according to claim, wherein said reaction product is substantially the product of a thermal reaction between a polyolefin and maleic anhydride.

9. A formulated product including the composition of claim 1 and at least 10 wt. % of an oil and 10 wt. % of an oil insoluble second phase, wherein at least 10 wt. % of a second phase which is insoluble in the oil phase (insoluble will be defined as not be soluble above 1 wt. % at 25 C).

10. A formulated product including the composition of claim 1, used as a dispersant or emulsifier in a personal care formulation, ink, coating, adhesive, lubricant (including refrigerant lubricant), metal working fluid, or fuel.

11-24. (canceled)
